(19) United States
(12) Patent Application Publication
(10) Pub. No.: US 2018/0152658 A1
(43) Pub. Date: May 31, 2018

(54) Remote Control System

(71) Applicant: William Adams, St. Paul, MN (US)

(72) Inventor: William Adams, St. Paul, MN (US)

(21) Appl. No.: 15/364,755

(22) Filed: Nov. 30, 2016

(51) Int. Cl. H04N 5/44

(52) U.S. Cl. CPC H04N 5/4403; H04N 2005/4426; H04N 2005/4428

(57) ABSTRACT

A remote control system includes a television that is in selective electrical communication with an extrinsic communication network thereby facilitating the television to display broadcast programming. A remote control is provided and the remote control is in wireless electrical communication with the television to control operational parameters of the television. The remote control includes a speaker to emit audible sounds. The speaker selectively emits audio from the television to inhibit audio from the broadcast programming to be audible beyond a predetermined distance from the remote control.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art including information disclosed under 37 CFR 1.97 and 1.98

The disclosure and prior art relates to remote devices and more particularly pertains to a new remote device for discretely emitting audio received from a television.

### (h) BRIEF SUMMARY OF THE INVENTION

An embodiment of the disclosure meets the needs presented above by generally comprising a television that is in selective electrical communication with an extrinsic communication network thereby facilitating the television to display broadcast programming. A remote control is provided and the remote control is in wireless electrical communication with the television to control operational parameters of the television. The remote control includes a speaker to emit audible sounds. The speaker selectively emits audio from the television to inhibit audio from the broadcast programming to be audible beyond a predetermined distance from the remote control.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a remote control system according to an embodiment of the disclosure.

FIG. 2 is a bottom phantom view of an embodiment of the disclosure.

FIG. 3 is a left side phantom view of an embodiment of the disclosure.

FIG. 4 is a top view of an embodiment of the disclosure.

FIG. 5 is a schematic view of an embodiment of the disclosure.

### (j) DETAILED DESCRIPTION OF THE INVENTION

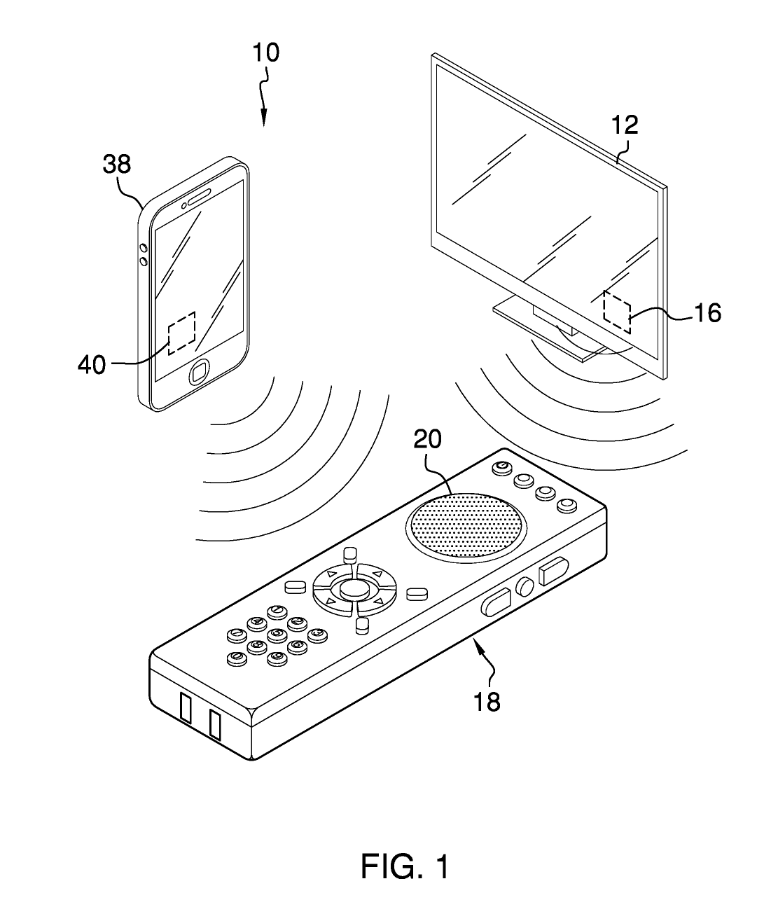

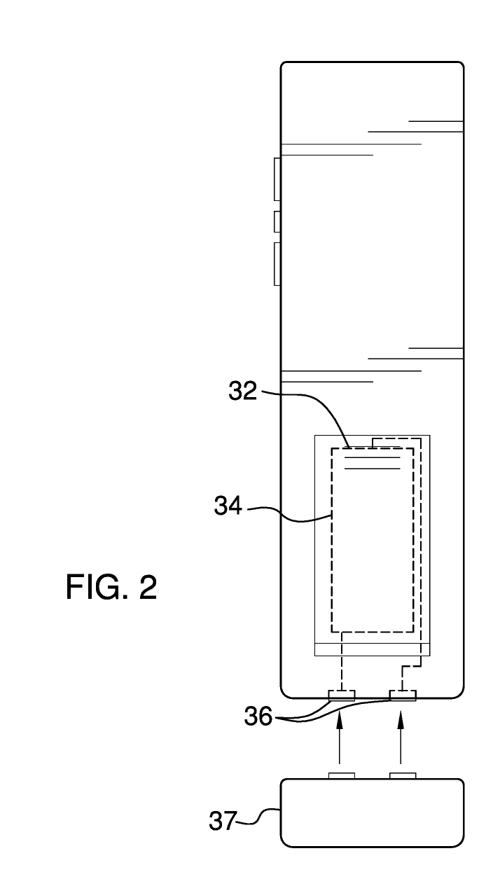

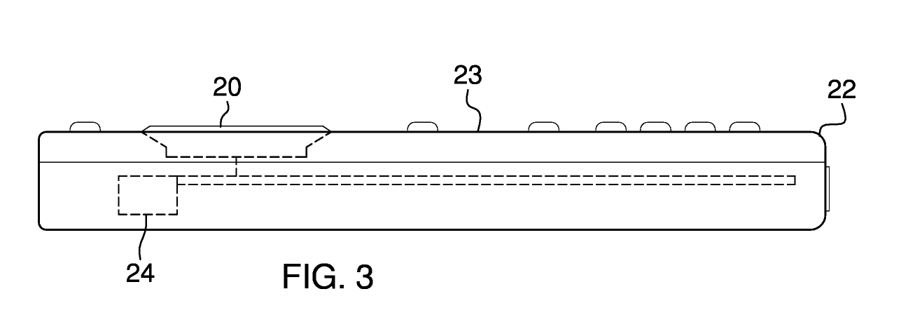

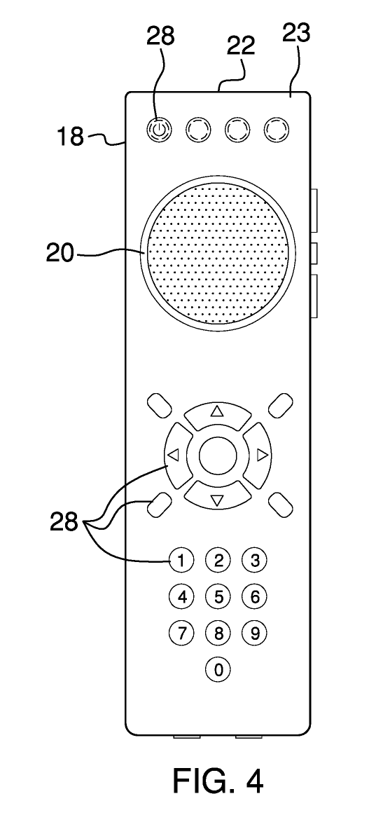

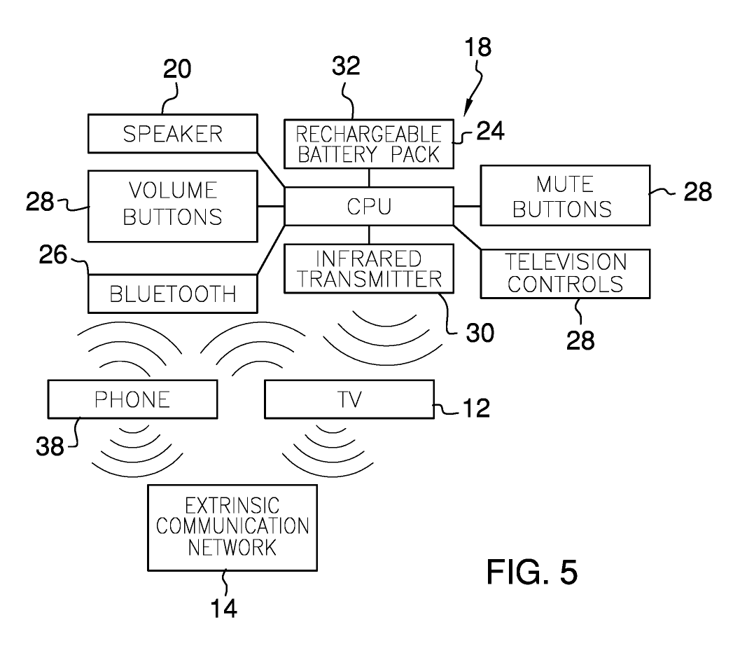

With reference now to the drawings, and in particular to FIGS. 1 through 5 thereof, a new remote device embodying the principles and concepts of an embodiment of the disclosure and generally designated by the reference numeral 10 will be described.

As best illustrated in FIGS. 1 through 5, the remote control system 10 generally comprises a television 12 that is in electrical communication with an extrinsic communication network 14 thereby facilitating the television 12 to display broadcast programming. The extrinsic communication network 14 may be a cable television system, the internet or other form of electronic communication. A first transceiver 16 is positioned within the television 12 and the first transceiver 16 is electrically coupled to the television 12. The first transceiver 16 is in electrical communication with the extrinsic communication network 14. The first transceiver 16 may be a radio frequency transceiver or the like and the first transceiver 16 may employ Bluetooth communication protocols.

A remote control 18 is provided and the remote control 18 is in wireless electrical communication with the television 12 such that the remote control 18 controls operational parameters of the television 12. The remote control 18 includes a speaker 20 to emit audible sounds. The speaker 20 selectively emits audio from the television 12 to inhibit audio from the broadcast programming to be audible beyond a predetermined distance from the remote control 18. The predetermined distance may be a distance ranging between approximately 3.0 meters and 6.0 meters. In this way the remote control 18 facilitates a user to watch television 12 without disturbing others who are nearby.

The remote control 18 comprises a housing 22 that may be manipulated and the housing 22 has a top side 23. A processor 24 is positioned within the housing 22 and the processor 24 may be an electronic processor or the like. A second transceiver 26 is positioned within the housing 22 and the second transceiver 26 is electrically coupled to the processor 24. The second transceiver 26 is in electrical communication with the first transceiver 16 such that processor 24 receives an audio signal from the first transceiver 16. The second transceiver 26 may be a radio frequency transceiver or the like and the second transceiver 26 may employ Bluetooth communication protocols. Thus, the second transceiver 26 may be selectively synched to the first transceiver 16.

The speaker 20 is coupled to the top side 23 of the housing 22 and the speaker 20 is electrically coupled to the processor 24. The speaker 20 may generate a maximum sound level ranging between approximately 12 dB and 18 dB. Thus, the sound emitted by the speaker 20 is not distinctly audible at a distance beyond approximately 20 feet from the speaker 20. A plurality of buttons 28 is provided and each of the buttons 28 is coupled to the top side 23 of the housing 22 to be manipulated. Each of the buttons 28 is electrically coupled to the processor 24 such that the plurality of buttons 28 controls the operational parameters of the television 12. The plurality of buttons 28 includes a power button, volume buttons, channel buttons, a synch button and other buttons related to remote controlled televisions.

An infrared transmitter 30 is coupled to the housing 22 to emit infrared light outwardly from the housing 22. The infrared transmitter 30 is electrically coupled to the processor 24 such that the infrared transmitter 30 transmits commands to the television 12 corresponding to the operational parameters of the television 12. The infrared transmitter 30 may be an infrared remote control 18 transmitter of any conventional design.

A power supply 32 is provided and the power supply 32 is coupled to the housing 22. The power supply 32 is electrically coupled to the processor 24. The power supply 32 comprises at least one battery 34 that is removably positioned within the housing 22. A charge port 36 is coupled to the housing 22 and the charge port 36 is electrically coupled to the at least one battery 34. The charge port 36 is selectively electrically coupled to a power source 37 thereby facilitating the at least one battery 34 to be charged. The power source 37 may be a battery 34 charger or the like.

An electronic device 38 is provided and the electronic device 38 is in electrical communication with the extrinsic communication network 14. The electronic device 38 has a third transceiver and the third transceiver is in electrical communication with the second transceiver 26. In this way the speaker 20 emits audio received from the electronic device 38. The electronic device 38 may be a smart phone or other electronic device 38 with internet connectivity. The third transceiver 40 may be a radio frequency transceiver and the third transceiver 40 may employ Bluetooth communication protocols.

In use, the remote control 18 is selectively manipulated to control the operational parameters of the television 12. The second transceiver 26 is selectively synched with the first transceiver 16 to facilitate the speaker 20 to emit audio received from the television 12. In this way the audible volume of the audio from the television 12 is reduced such that the audio from the television 12 is not audible beyond the predetermined distance. The second transceiver 26 is selectively synched to the third transceiver 40 to facilitate the speaker 20 to emit audio received from the electronic device 38. In this way the audio from the electronic device 38 may be listened to simultaneously while listening to audio from the television 12.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A remote control system comprising:
a television being configured to be in electrical communication with an extrinsic communication network thereby facilitating said television to display broadcast programming;
a first transceiver being positioned within said television, said first transceiver being electrically coupled to said television;
a remote control being in wireless electrical communication with said television such that said remote control controls operational parameters of said television, said remote control including a speaker, said speaker being configured to emit audible sounds, said speaker selectively emitting audio from said television wherein said remote control is configured to inhibit audio from the broadcast programming to be audible beyond a predetermined distance from said remote control, said remote control including a processor;
a second transceiver, said second transceiver being electrically coupled to said processor, said second transceiver being in electrical communication with said first transceiver such that processor receives an audio signal from said first transceiver;
a smart phone being configured to be in electrical communication with the extrinsic communication network; and
a third transceiver, said third transceiver being in electrical communication with said second transceiver such that said speaker emits audio received from said smart phone.

2. (canceled)

3. (canceled)

4. (canceled)

5. The system according to claim 1, further comprising:
said remote control including a housing having a top side; and
said speaker being coupled to said top side of said housing, said speaker being electrically coupled to said processor.

6. The system according to claim 1, further comprising:
said remote control including a housing having a top side; and
a plurality of buttons, each of said buttons being coupled to said top side of said housing wherein each of said buttons is configured to be manipulated, each of said buttons being electrically coupled to said processor such that said plurality of buttons controls the operational parameters of said television.

7. The system according to claim 1, further comprising:
said remote control including a housing; and
an infrared transmitter being coupled to said housing wherein said infrared transmitter is configured to emit infrared light outwardly from said housing, said infrared transmitter being electrically coupled to said processor such that said infrared transmitter transmits commands to said television corresponding to the operational parameters of said television.

8. The system according to claim 1, further comprising:
said remote control including a housing; and
a power supply being coupled to said housing, said power supply being electrically coupled to said processor.

9. The system according to claim 8, wherein said power supply comprises at least one battery being removably positioned within said housing.

10. The system according to claim 9, further comprising a charge port being coupled to said housing, said charge port being electrically coupled to said at least one battery, said charge port being configured to be selectively electrically coupled to a power source thereby facilitating said at least one battery to be charged.

11. A remote control system comprising:
a television being configured to be in electrical communication with an extrinsic communication network thereby facilitating said television to display broadcast programming;
a first transceiver being positioned within said television, said first transceiver being electrically coupled to said television;
a remote control being in wireless electrical communication with said television such that said remote control controls operational parameters of said television, said remote control including a speaker, said speaker being configured to emit audible sounds, said speaker selectively emitting audio from said television wherein said remote control is configured to inhibit audio from the broadcast programming to be audible beyond a predetermined distance from said remote control, said remote control comprising:
a housing being configured to be manipulated, said housing having a top side,
a processor being positioned within said housing,
a second transceiver being positioned within said housing, said second transceiver being electrically coupled to said processor, said second transceiver being in electrical communication with said first transceiver such that processor receives an audio signal from said first transceiver,
said speaker being coupled to said top side of said housing, said speaker being electrically coupled to said processor,
a plurality of buttons, each of said buttons being coupled to said top side of said housing wherein each of said buttons is configured to be manipulated, each of said buttons being electrically coupled to said processor such that said plurality of buttons controls the operational parameters of said television,
an infrared transmitter being coupled to said housing wherein said infrared transmitter is configured to emit infrared light outwardly from said housing, said infrared transmitter being electrically coupled to said processor such that said infrared transmitter transmits commands to said television corresponding to the operational parameters of said television, and
a power supply being coupled to said housing, said power supply being electrically coupled to said processor said power supply comprising:
at least one battery being removably positioned within said housing, and
a charge port being coupled to said housing, said charge port being electrically coupled to said at least one battery, said charge port being configured to be selectively electrically coupled to a power source thereby facilitating said at least one battery to be charged; and
a smart phone being configured to be in electrical communication with the extrinsic communication network, said electronic device having a third transceiver, said third transceiver being in electrical communication with said second transceiver such that said speaker emits audio received from said smart phone.
